(19) United States
(12) Patent Application Publication
(10) Pub. No.: US 2007/0258203 A1
(43) Pub. Date: Nov. 8, 2007

(54) Decorative Add-On Frame For An Electronic Monitor

(76) Inventor: Robin Sturmthal, Woodland Hills, CA (US)

Correspondence Address: FISH & ASSOCIATES, PC;ROBERT D. FISH, 2603 Main Street, Suite 1050, Irvine, CA, 92614-6232, US

(21) Appl. No.: 11/762,637

(22) Filed: Jun. 13, 2007

Related U.S. Application Data
(62) Division of application No. 11/203,560, filed on Aug. 12, 2005.
(60) Provisional application No. 60/649,324, filed on Feb. 1, 2005.

(51) Int. Cl. G06F 1/16

(52) U.S. Cl. 361/683

(57) ABSTRACT

A frame for covering a rim of a computer monitor having a first and second side members and a coupler that interconnects and restricts relative movement between the side members. The frame further includes a face separable from the coupler that obscures (a) at least a portion of the coupler and (b) at least a portion of an end of each of the side members from a view of a user of the monitor. The side member also includes a decorative pattern, which shares a theme with an electronic image that can be displayed on the monitor.

This application claims the benefit of U.S. provisional application No. 60/649,324 filed on Feb. 1, 2005 incorporated herein by reference in its entirety.

### FIELD OF THE INVENTION

The field of the invention is computer monitor display accessories.

### BACKGROUND OF THE INVENTION

A computer monitor or other electronic display device typically has an unadorned border surrounding its display screen. It has become known to adorn the border of an electronic monitor screen by adhering objects to it including objects that substantially frame the entire monitor screen. In order to accommodate the varying sizes of monitor screens, however, frames need to be produced in a multitude of sizes. U.S. Pat. No. 6,412,744 addresses this problem by teaching an adjustable monitor frame that can be used on a variety of differently sized monitors. One of the problems with the design taught in the '744 patent is that unsightly corner seams are left exposed.

There is a need for methods and devices which provide an adjustable display frame for computer monitor screens and all other electronic display screens that also ameliorates the appearance of the corner seams.

### SUMMARY OF THE INVENTION

The present invention provides a frame for covering a rim of an electronic display. This frame has a first and second side members and a coupler that interconnects and restricts relative movement between the side members. Further, the frame includes a face separable from the coupler that obscures (a) at least a portion of the coupler and (b) at least a portion of an end of each of the side members from a view of a user of the monitor.

In another aspect, the present invention provides a monitor display system having a monitor frame with side members coupled together, a face plate, and an electronic image that can be displayed on the monitor.

Contemplated frame can have a decorative pattern that shares a theme with an electronic image on the monitor. And the electronic image can be displayed as a wallpaper and/or a screen saver.

In preferred embodiments the side members are made of a rigid substance such as molded plastic. Other suitable materials include, for example, fiberglass, cardboard, polymeric material, and so forth.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a front view of a monitor frame on a computer system.

FIG. 2 is an exploded view of a monitor frame.

FIG. 3 is an exploded view showing one corner of a monitor frame.

FIG. 4 is an exploded view showing one corner of a monitor frame where the side members are further apart than shown in FIG. 3.

FIG. 5 is an exploded view showing one corner of the monitor frame where the two side members are not mitered.

FIG. 6 is a view of one embodiment of a monitor frame.

FIG. 7 is a view of one embodiment of a monitor frame.

FIG. 8 is a view of one embodiment of a monitor frame having a pocket.

FIG. 9 is a front view of a monitor display system without face plates where an electronic image shares a theme with the decorative pattern of a monitor frame.

FIG. 10 is a front view of a monitor display system with face plates where an electronic image shares a theme with the decorative pattern of a monitor frame.

FIG. 11 is a front view of a side member having perforations.

### DETAILED DESCRIPTION

As used herein, the term “computer” refers to any general-purpose data processing machine, including especially those running popular operating systems such as DOS, VM and MVS (or IBM™ mainframes), VMS (for DEC machines), UNIX™ (including proprietary variations such as AIX, Ultrix, and UNICOS), Microsoft™ Windows, Microsoft™, OS/2, and Apple™ OS.

As used herein, the term “monitor” refers to an electronic display comprising of a device that takes signals from a computer and displays the signal on an electronic screen.

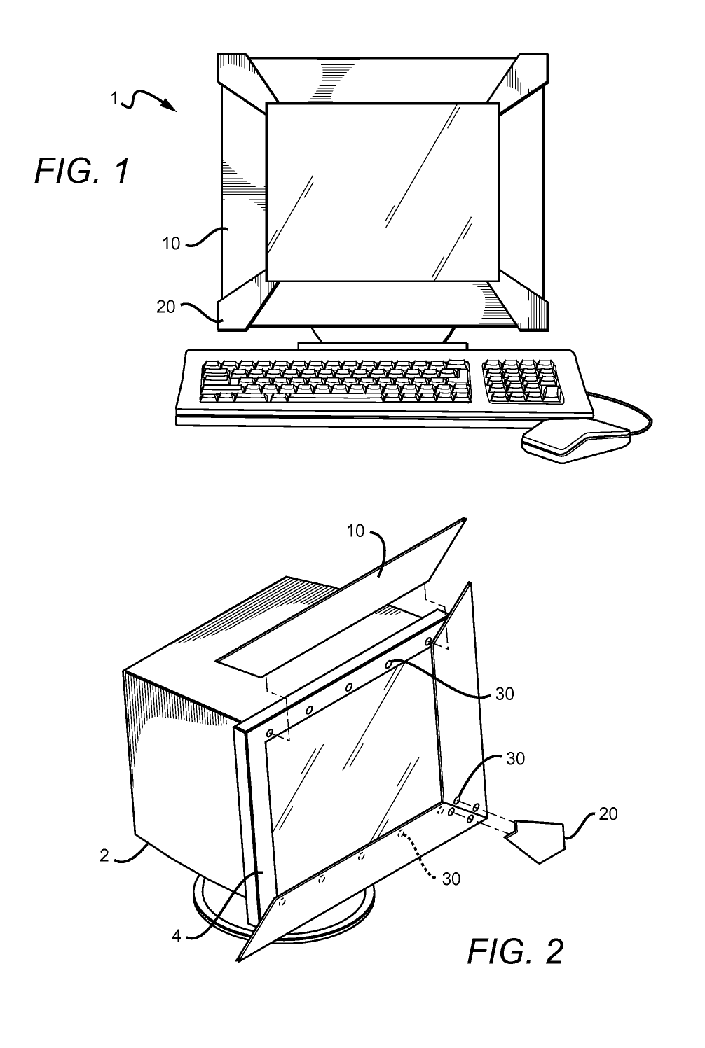

Referring first to FIGS. 1 and 2. A frame 1 has side members 10 and face 20. Side members are attached to the rim 4 of a monitor 2 by using couplings 30. Various known types of couplings can be used, for example, hook-and-loop coupling, double-sided adhesive tape.

In one aspect of the invention, the side members 10 are attached to rim 4. Therefore rim 4 acts as a coupling device that interconnects and restricts relative movement between the side members.

In FIG. 1, a separate face 20 attaches to side members 10 using couplings 30. Various known types of couplings can be used, for example, hook-and-loop coupling, double-sided adhesive tape.

The face 20 obscures (a) at least a portion of the rim 4 and (b) at least a portion of an end of each of the side members 10 from a view of a user of the computer monitor.

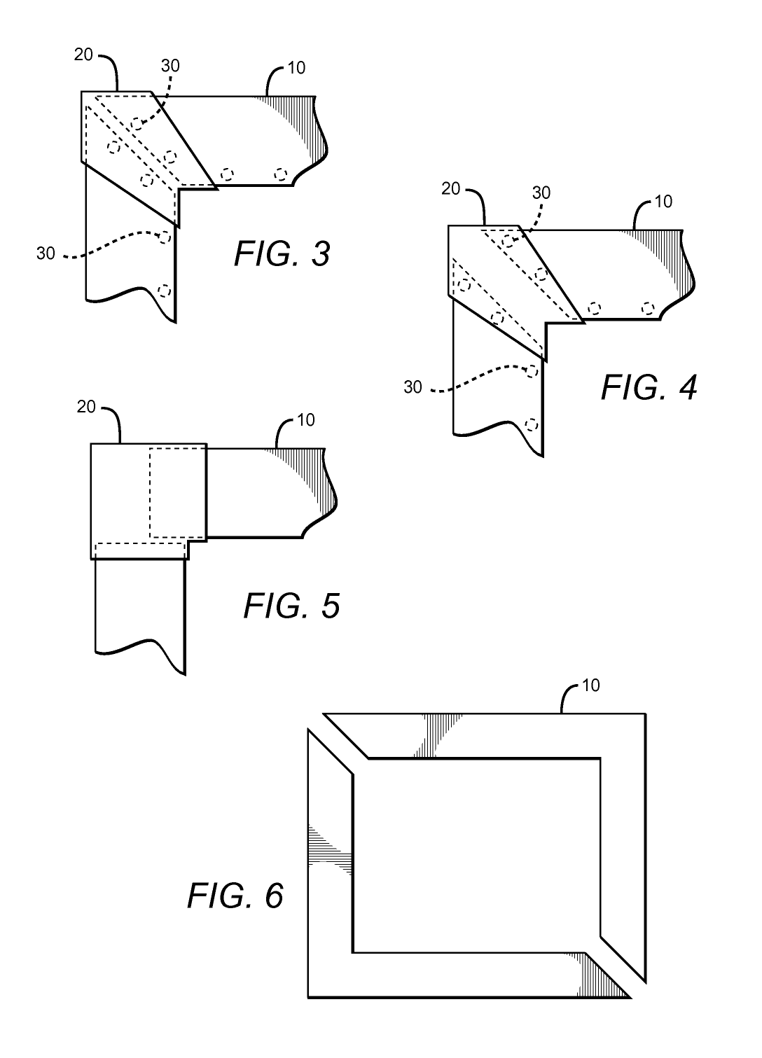

As shown in FIGS. 3 and 4, the face obscures the gap between two adjacent side members 10, and is sized and dimensioned to obscure gaps as wide as 10 cm. This way, a user can arrange the side members 10 such that frame 1 can fit a number of monitor sizes without showing unsightly gaps.

It should be noted that side members 10 do not necessarily miter at its ends. The ends of side members 10 can have different geometric shapes, such as rectangular shape as shown in FIG. 5.

In one embodiment, the face 20 can be inseparable from a side member 10. As such, the face is inseparably attached to a side member 10 and covers the gap between the side member and another side member.

In a preferred embodiment, the side members 10 has a trapezoid shape as shown in FIGS. 1 and 2.

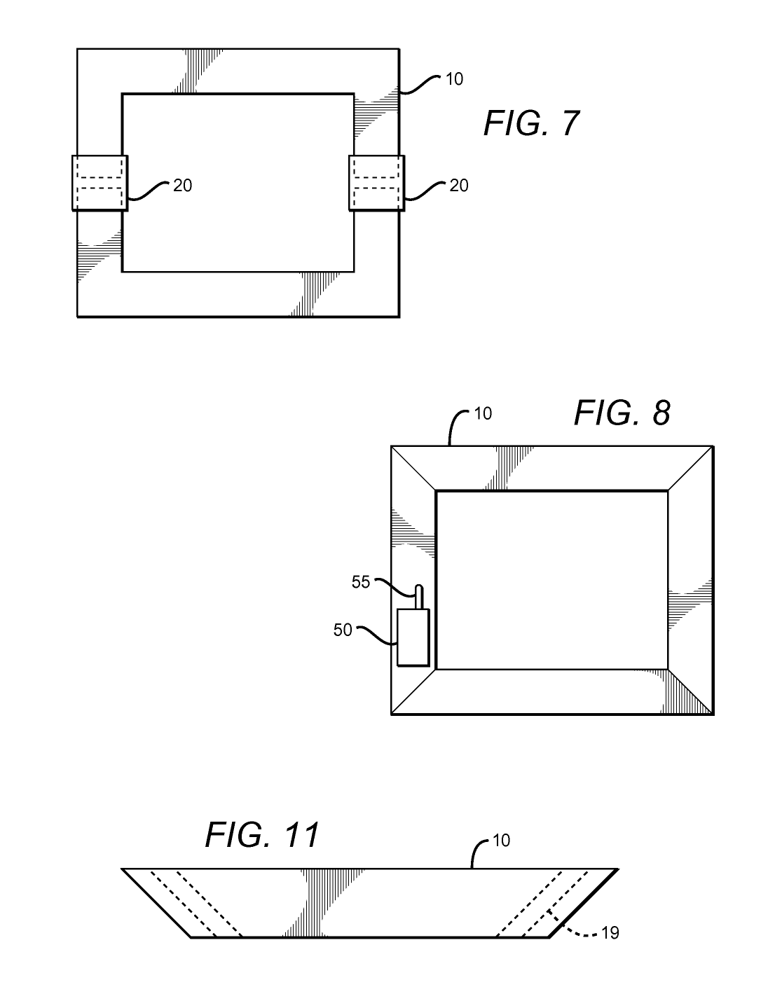

FIG. 6 illustrates one configuration of the side member 10 where each side member is substantially “L” shaped and includes just one corner. FIG. 7 illustrates one configuration of the side members 10 where each side member is substantially “U” shaped and includes two corners.

In further preferred embodiments, the frame has a pocket 50 for holding small items. In FIG. 8, the pocket 50 holds a pencil 55. Other embodiments can have a pocket for holding eye glasses, or the pocket can be a water vial holder for flowers. In another embodiment, clear vinyl pockets are provided on various locations of the device for holding photographs, memos, or other articles. It should be appreciated that the pocket can have various sizes, shapes, and be located at different locations on the side members 10.

One aspect of the current invention includes having decorative covering on side members 10. The type of decorative covering is purely design choice, which may be: a fabric; a printed image; an animal print; a covering with a texture that simulates animal fur; a polymeric covering that simulates a surface of a basketball.

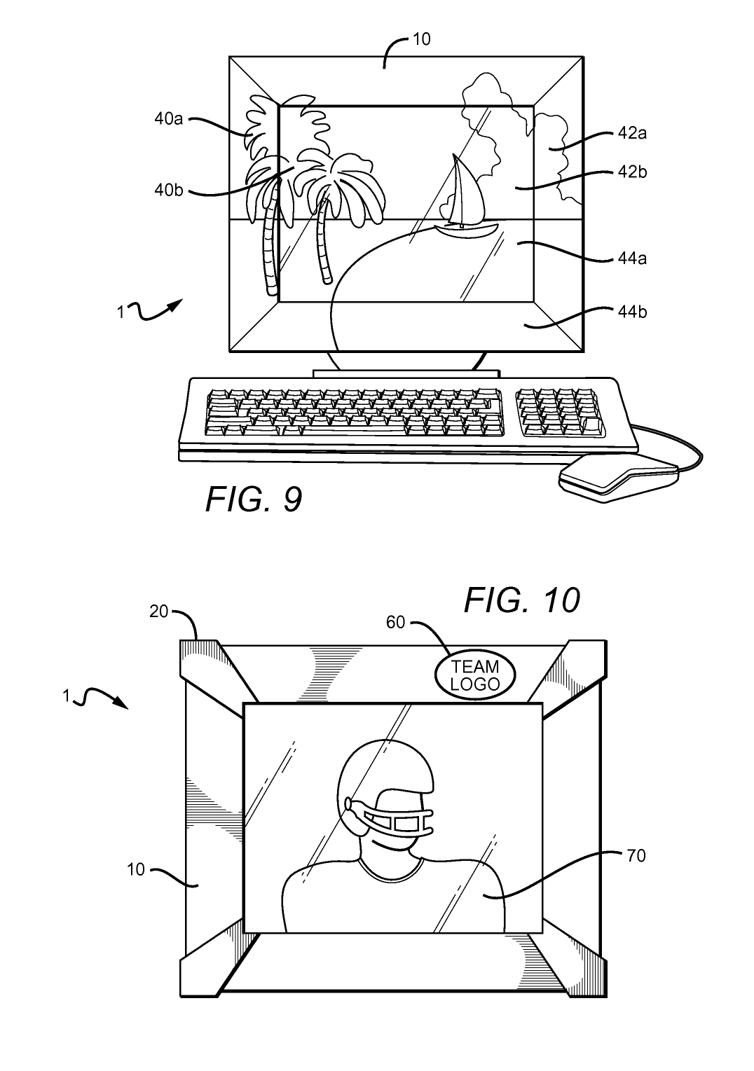

In another aspect of the current invention as illustrated in FIGS. 9 and 10, a monitor display system has a monitor frame 1 and an electronic image display. This electronic image can be a wallpaper or a screen saver, or can be an image file displayed via a computer application.

It is contemplated that the decorative pattern on the frame shares a theme with the electronic image. A multitude of themes maybe implemented, for example: Sports, automobiles, scenic photography, flowers, animals, landscape, travel, people, cartoon characters, sports teams and players (as in FIG. 10), famous celebrities, boating, aviation, movie posters, aquatic life, the beach, images of the space. Using a specific theme is purely design choice and it should be noted that this is only a short list of possible themes.

In FIG. 9, the frame is contemplated to have a pattern that extends into the electronic image. For example, palm trees 40A and 40B, clouds 42A and 42B, water 44A and 44B visually blends into one another.

In FIG. 11, side member 10 has perforations 19 that can be broken out to provide a side member having a desired length. Side member 10 with perforations 19 is preferably made of a rigid substance such as molded plastic or vinyl. Other suitable materials include, for example, fiberglass, cardboard, polymeric material, and so forth. These materials are also suitable for side members 10 without perforations 19.

In addition, side members can have a traditional picture frame design, made from stained foam core or other wooden or light weight synthetic polymer moulding. These materials and designs provide a three-dimensional texture and has face 20 that corresponds to the three-dimensional shape of the side members. The face for this embodiment can have a face that resembles a corbel.

Methods of manufacturing the side members 10 and face 20 is as follows: For side members and faces made of fabric, 30 pt. polystyrene can be used as a stiffener. Other preferred materials for stiffener includes chipboard, or other polymeric materials.

Another preferred mode of manufacture is to print desired image to 10 pt paper, laminating it, and then mounting the printed paper on both sides of 20 pt polystyrene followed by diecutting. Another preferred manufacturing method includes printing directly to a gloss trans vinyl, or trans alloy. Optionally, polyethelene and polystyrene can be used. As for printing process, 4 color process printing and screenprinting can be used.

Suitable ways of attaching decorative covering to the side members include sewing. Contemplated side member can also be padded or upholstered with a paper or vinyl backed foam stiffener.

It is contemplated that a bookbinding method can be used to produce side members and faces made of faux metallic coated papers. This method utilizes a potdevin gluer and subsequently gluing the paper to a styrene or chipboard stiffener. Bookbinding can be used for any paper-backed material, including vinyls. A permanent spray mount would also work.

All sizes of the frame is contemplated. Preferred frame size is to accommodate computer monitors range from 15″ to 23″ standard size (mostly a 3:4 ratio) as well as the various sized 16:9 ratio monitor that is becoming more popular. Another embodiment of the present invention is to accommodate electronic display screens where the entire rim of the electronic display is made from single injection molding. Other preferred frame sizes are also contemplated to accommodate other electronic devices with electronic displays of various sizes. These general electronic devices includes televisions, cellular phones, PDAs (Personal Digital Assistant), billboards, casino gaming machines, automotive instrument displays, audio-visual equipment displays, close-circuit monitors, and the like.

Thus, specific embodiments and applications of decorative computer monitor frame have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1-23. (canceled)

24. A decorative add-on frame for an electronic monitor, comprising at least four separable side pieces.

25. The decorative frame of claim 24, further comprising a corner piece distinct from the side pieces.

26. The decorative frame of claim 24, wherein the corner piece is sized and dimensioned to receive ends of two of the side pieces.

27. The decorative frame of claim 24, wherein the separable side pieces comprise a molded plastic.

28. The decorative frame of claim 24, wherein the separable side pieces are sized and dimensioned to frame comprise a molded plastic.

29. The system of claim 1 wherein at least one of the side pieces further comprises a clear pocket.
